(19) United States
(12) Patent Application Publication
(10) Pub. No.: US 2024/0119861 A1
(43) Pub. Date: Apr. 11, 2024

(54) ELECTRONIC DEVICE AND METHOD FOR TRAINING EXECUTIVE PRESENCE

(71) Applicant: YOUR SPEECH FACTORY AB, Malmo (SE)

(72) Inventor: Vincenzo De Salvo, Berlin (DE)

(21) Appl. No.: 17/962,952

(22) Filed: Oct. 10, 2022

(51) Int. Cl. G09B 19/04; G06F 3/01; G06T 13/40; G06V 40/16; G06V 40/18; G06V 40/20; H04L 12/18

(52) U.S. Cl. CPC G09B 19/04; G06F 3/013; G06T 13/40; G06V 40/161; G06V 40/174; G06V 40/18; G06V 40/20; H04L 12/1822

(57) ABSTRACT

The present disclosure relates to the area of training executive presence. According to a first aspect, the disclosure relates to a computer-implemented method for training executive presence of a user when delivering a speech to a virtual audience though the electronic user device. The method includes, upon a determined current body pose failing to meet criteria defining executive presence based on body pose and whether the user is currently speaking, providing a user interface object indicative of a direction of a body movement that would result in a body pose that meets the criteria defining executive presence. The disclosure also relates to an electronic user device and to a computer program configured to perform the method.

### TECHNICAL FIELD

The present disclosure relates to the area of training executive presence. More specifically, the present disclosure proposes a method performed by an electronic user, for training executive presence of a user delivering a speech to a virtual audience though the electronic user device. The disclosure also relates to an electronic user device and to a computer program configured to perform the method.

### BACKGROUND

Giving online presentations is an important skill to many people today. For a speaker to deliver persuasive and engaging presentations, the speaker should follow specific speech rules that executive presence.

There are many systems on the market aiming at aiding users that give speeches. These systems are commonly focused on aiding the speaker in establishing good eye-contact during the speech. For example, patent publication WO2021040602 A1 discloses an electronic device and a method for eye contact training.

However, it has turned out that only analysing eye contact is not always sufficient to achieve executive presence. Hence, there is a need for further improvements in this area.

### SUMMARY

It is an object to provide technique aiding users in achieving executive presence while giving speeches to a virtual audience via a user device. Furthermore, it is an object to provide a technique that can be readily implemented in various user devices with reasonable demand on hardware and software.

According to a first aspect, the disclosure relates to a computer-implemented method, performed by an electronic user device comprising one or more displays and a camera, for training executive presence of a user when delivering a speech to a virtual audience though the electronic user device. The method comprises capturing images of the user in an ongoing manner during the speech and using the camera; determining, based on feature recognition in the images, a current body pose of the user, including determining a head orientation of the user and determining whether the user is currently speaking. The method further comprises, upon the determined current body pose failing to meet criteria defining executive presence based on body pose and whether the user is currently speaking, providing, on the display, a user interface object indicative of a direction of a body movement that would result in a body pose that meets the criteria defining executive presence. The proposed method involves analysing behavioural aspects, such as body pose, that are crucial to achieve executive presence and combining them to analyse whether the user's current behaviour is satisfactory. By indicating to the user how to correct his or her body pose, as soon as the current body pose fail to meet criteria defining executive presence, the user's attention is immediately drawn to the deviation. The user interface object enables the user to immediately correct the unsatisfactory behaviour, whereby executive presence can be maintained. The proposed method may be used to implement various schools of thought regarding executive presence.

In some embodiments, the user interface object is an animated object imaging a user performing the body movement that would result in a body pose that meets the criteria defining executive presence. An animated user interface object reflecting the user may catch the user's attention and guide the user to a correct position.

In some embodiments, the user interface object is indicative of a size of a deviation between the current body pose and a body pose that would meet the criteria defining executive presence. For example, a significant deviation may be represented by user interface object that the user cannot avoid seeing. Thereby, the user is alerted when the deviation is significant.

In some embodiments, the size is represented by a length, width, type, or animation of the user interface object. Hence, various shapes may be implemented depending on implementation.

In some embodiments, the providing also comprises providing, to the user, a stereo audio signal indicative of the direction of the body movement that would result in a body pose that meets the criteria defining executive presence. The audio signal may be used as additional assistance to the user.

In some embodiments, the user interface object is displayed based other user interface objects presented on the display, to avoid that the other user interface objects remain visible. Thereby, the risk that the user is disturbed during the speech is reduced. For example, it should be avoided that the user interface object covers the user's notes or the virtual audience.

In some embodiments, the method comprises ceasing in providing the user interface object upon the determined current body pose meeting criteria defining executive presence based on body pose and whether the user is currently speaking. Thereby, the user is notified when the unsatisfactory behaviour has been corrected.

In some embodiments, the criteria establish executive presence based on that a deviation between a direction that the user is facing, and the camera, shall be below a predefined angle while the user is speaking, in order to give a feeling of eye contact. Hence, the criteria may be tuned to alert the user when looking away from the camera.

In some embodiments, the criteria establish executive presence based on that a deviation between a direction that the user is facing, and an image on the display of a person of a virtual audience, shall be below a predefined angle while the user is speaking, to enable the user to read emotions of the virtual audience. Hence, the criteria may alternatively or additionally be tuned to alert the user when looking away from the virtual audience.

In some embodiments, the determining whether the user is speaking performed by analysing lip movement in the images. Thereby, the method may be performed based only on a signal provided by an image sensor or camera.

In some embodiments, the analysing comprises determining a variation of the distance between predefined positions along an outer boundary of the user's mouth. This is one example of how speech may be detected.

In some embodiments, the determining a current body pose also comprises determining a gaze direction of the user. By also analysing the gaze direction, the analysis of executive presence may be even further improved.

In some embodiments, the speech takes place in a video conference, and wherein the user interface object is presented within or adjacent to the user interface of a video conference interface of the video conference. Hence, the proposed technique may be integrated with software used for a video conference.

According to a second aspect, the disclosure relates to an electronic user device comprising a one or more displays and a camera, wherein the electronic user device comprises a control arrangement. The control arrangement is configured to cause the electronic user device to capture, in an ongoing manner during the speech and using the camera, images of the user, to determine, based on feature recognition in the images, a current body pose of the user, including determining a head orientation of the user, and to determine whether the user is currently speaking. The control arrangement is further configured to, upon the determined current body pose failing to meet criteria defining executive presence based on body pose and whether the user is currently speaking, provide on the display, a user interface object indicative of a direction of a body movement that would result in a body pose that meets the criteria defining executive presence.

In some embodiments, the electronic user device is configured to perform the method according to any one of the embodiments of the first aspect.

According to a third aspect, the disclosure relates to a computer program comprising instructions which, when the program is executed by a control arrangement, cause the electronic user device to carry out the method as described herein.

According to a fourth aspect, the disclosure relates to a computer-readable medium comprising instructions which, when executed by a control arrangement, cause the electronic user device to carry out the method as described herein.

### BRIEF DESCRIPTION OF THE DRAWINGS

FIG. 1 illustrates a user positioned in front of a user interface device.

FIGS. 2A to 2B illustrates correct and incorrect head orientation of a user.

FIGS. 3A to 3B different example user interface object indicative of a direction of a body movement provided on a display of an electronic user device.

FIGS. 4A and 4B illustrate further example user interface object indicative of a direction of a body movement provided on a display.

FIG. 5 is a flow chart of the proposed method according to the first aspect.

FIG. 6 illustrate positions along an outer boundary of the user's mouth.

FIG. 7 illustrate standard deviation between positions along an outer boundary of the user's mouth.

FIG. 8 illustrates an electronic user device according to one example embodiment.

FIG. 9 illustrate an animated user interface objects imaging a user.

FIGS. 10-11 illustrate the animated user interface object in further detail.

### DETAILED DESCRIPTION

The inventors have designed a method for giving real-time feedback regarding to a user during a speech, based on specific speech rules defining executive presence (such as public speaking best practice), by providing a user interface configured to guide the user on a display.

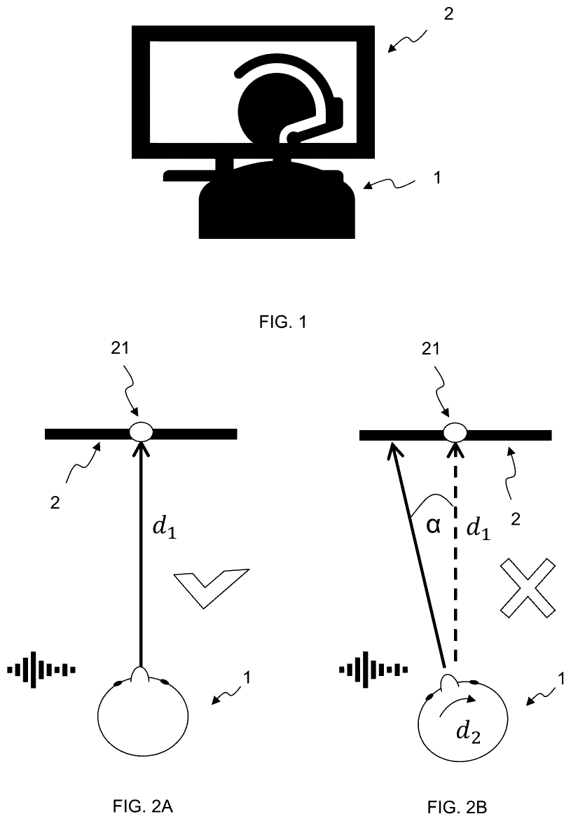

The proposed technique will now be further described with reference to FIG. 1 to FIG. 8. FIG. 1 illustrates a user 1 positioned in front of an electronic user device 2 device when delivering a speech to a virtual audience though the electronic user device 2. The electronic user device 2 is here illustrated as a personal computer but may include any electronic user device suitable for the purpose, such as a tablet, smartphone or similar.

There are at least two schools of thought regarding what user behaviour results in best executive presence. The first school implies that in a virtual meeting, the speaker needs to talk to the webcam to give a feeling of eye contact rather than looking at the image of the person in the virtual environment (such as teams or zoom). The second school implies that in a virtual meeting, the speaker needs to talk to a person appearing on the display 21 to read be able to read the emotions of the virtual audience. Common for both schools is that the speaker can, to at least some extent, look anywhere while in silence (taking a pause), for example reading the notes place on the desk. However, the speaker needs to look at the camera (school 1) or the virtual audience (school 2) while talking. The problem is that quite often speakers look around or read our notes while talking in an online presentation. This is not the best practice.

The technique proposed herein can be used independently on what school of thought is applied. More specifically, the proposed technique is based on that various properties of the user are monitored and that depending on what school of thought is applied different criteria can be applied to give relevant feedback to the user.

For the software implementing the method to understand the user's behavior, it needs to analyze several user's biometrics, such as whether the user talking or not talking, whether the user facing the screen/camera or not etc. In some embodiments, further properties are monitored, such as whether the user's gaze is directed at a certain object, such as into the camera or at the virtual audience. In further embodiments, the method may be based on further behavior detectable by a camera. The monitoring may be done in different ways as will be further described below.

In one example implementation, determination whether the user 1 is facing the camera 22 is based on position and orientation of the head of the user 1. The position and orientation may be analyzed in horizontal and vertical direction. Pose estimation specifically refers to the relative orientation of the head with respect to a camera. For example, certain points in the face of the user are detected. The points may include one or more or all of; outer position of eyes and mouth (with respect to the center of the face), tip of nose and tip of chin. Various known techniques for pose estimation, such as “Real-Time Head Pose Estimation With OpenCV and Dlib”, by Sabbir Ahmed (see https://medium.com/analytics-vidhya/real-time-head-pose-estimation-with-opencv-and-dlib-e8dc10d62078).

Head orientation may then be estimated based on the how distances in-between these points vary. The calculation may result in a direction d₁ that represent a direction that the user 1 is facing. In some embodiments, the direction d₁ corresponds to a direction of the nose of the user. FIG. 2A illustrates an example of correct head orientation of a user 1. In FIG. 1 the user is looking straight at the camera.

In some embodiments, one may define a reference angle α₁ (e.g., within 15 degrees from the camera) to delimit a target area where the user shall look while talking to have satisfactory executive presence. FIG. 2B illustrates an example incorrect head orientation of a user, where the direction d₁ is outside the reference angle α₁ while talking. A direction d₂ of a body movement, here turning of head, required for satisfactory executive presence is illustrated by the arrow. In other words, the direction d₂ may start at an origin, where the user is currently facing and head at a correct position, that the user 1 should face.

The proposed technique includes provision of a user interface object 24 that illustrate a movement that can mitigate incorrect body position, such as a bad head orientation. When giving a speech via an electronic user device 2 a user interface is shown to the user 1. The user interface typically comprises images (video) of the people in the virtual audience 27 and some other data such as user noted or a shared presentation 26.

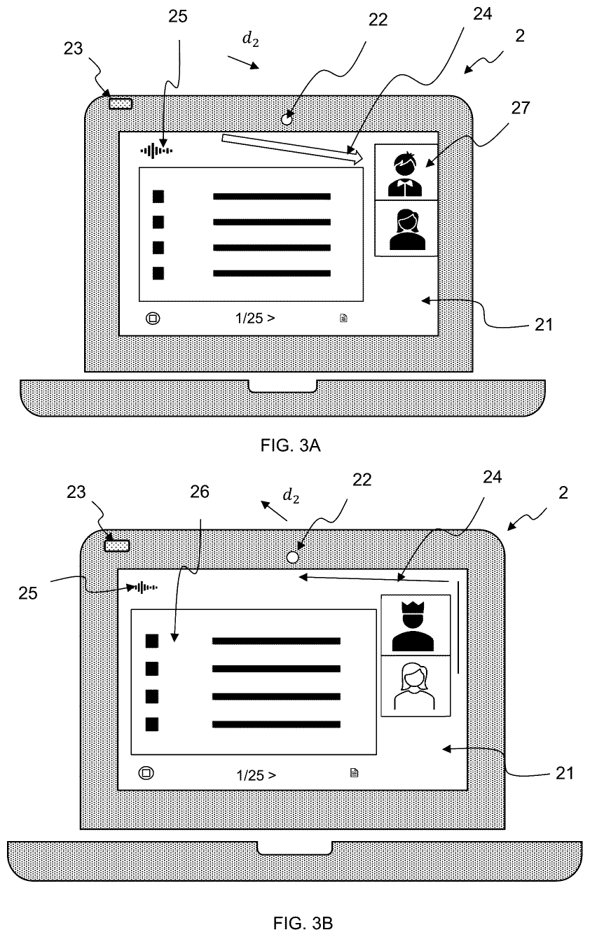

FIGS. 3A to 3B illustrate different example user interface objects 24 indicative of a direction d₂ of a body movement. The user interface objects 24 are provided on a display 21 of an electronic user device 2. The electronic user device 2 comprises one or more displays 21 and a camera 22. The illustrated electronic user device 2 also comprises a microphone 23. In the example of FIG. 3A the second school, where the user should look at the virtual audience is implemented. In this example, the user is facing the virtual audience, but the upper left corner of the display, while the user is talking. The head orientation and the talking are detected based on images captured by the camera 22. A user interface object 24 illustrating a head movement that would correct this deviation from a desired head orientation is illustrated in the shape of an angle pointing from where the user is currently facing to where the user should face.

In FIG. 3B the first school of thought where the user 1 should look into the camera 22 is implemented. In this example, the user 1 is currently facing down to the right while talking. A user interface object 24 shaped as a curved arrow is then presented to cause the user 1 to turn his head up and left.

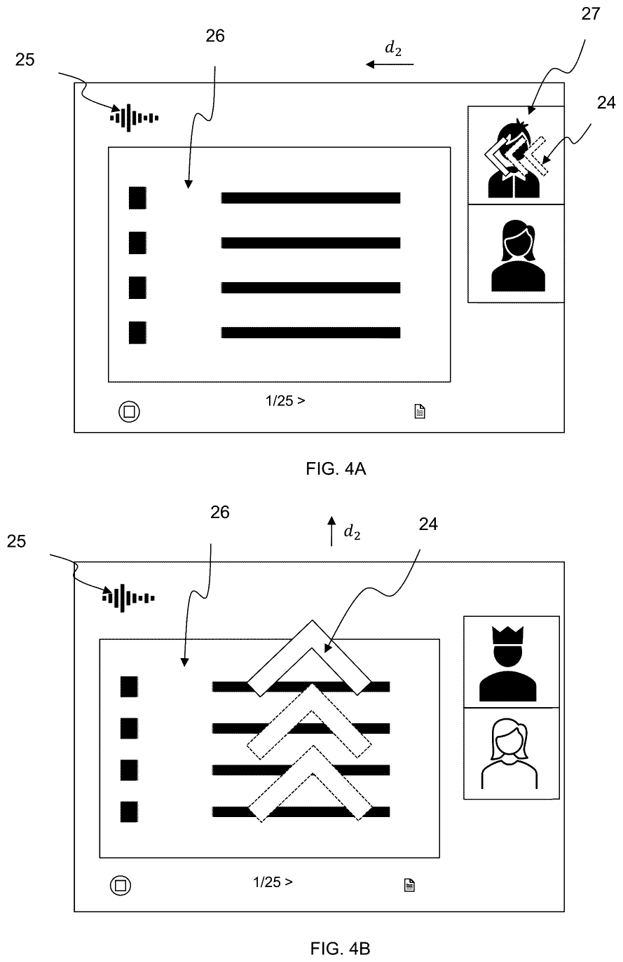

FIGS. 4A and 4B illustrate further example user interface objects 24 indicative of a direction d₂ of a body movement. In FIG. 4A the user 1 is currently looking outside the display 21 while talking. More specifically, to the right of the display 21. In this example, the second school of thought where the user 1 should look at the virtual audience is implemented. Three arrows are presented on the display 21 to indicate to the user that he/she should turn his head to the left.

In FIG. 4B the user 1 is bending his/her head down. Arrows are then presented alerting the user to look up. In these examples, one may not be sure that the user is really watching the display 21. Hence, to further draw the attention to the undesirable behaviour the user interface object 24 may be animated, to further emphasize the desired body movement. For example, the arrows may appear sequentially in an order that further emphasizes the direction. The animation may in addition serve the purpose of drawing the user's attention to the user interface object 24. In addition, colors may be used to draw attention to the user interface object 24.

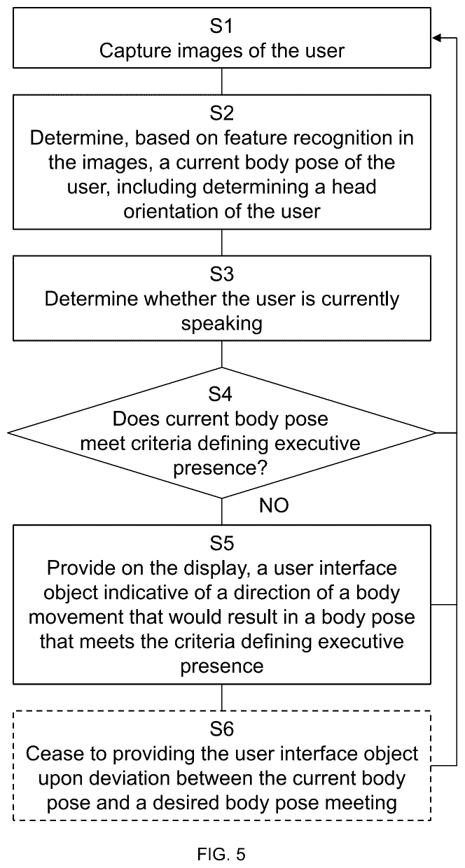

The proposed technique will now be described in further detail with reference to the flowchart of FIG. 5, which illustrates the proposed method for training executive presence of a user 1 when delivering a speech to a virtual audience though the electronic user device 2 in a flow chart. The method is performed by an electronic user device 2 comprising one or more displays 21 and a camera 22 (FIG. 3A-3B, FIG. 8). The method is typically implemented in a control arrangement 20 of the electronic user device 2 (FIG. 8). In an example embodiment, the method is performed by a video conferencing software installed on the user device 2 when a user 1 is speaking to a virtual audience using the video conferencing software. In other words, in some embodiments the speech takes place in a video conference, and the user interface object 24 is presented within or adjacent to the user interface of a video conference interface of the video conference.

The steps of the method may be defined in a computer program, comprising instructions which, when the program is executed by one or more processors (e.g., control arrangement 20), causes the electronic user device 2 to carry out the method. The steps of the method may also be defined in a computer-readable medium, e.g., an internal memory of the control arrangement 20 and/or in any other memory. The computer-readable medium comprises instructions that, when executed by a control arrangement 20, causes the electronic user device 2 to carry out the method.

The procedure may be initiated by a user 1 starting a certain software application on the electronic user device 2. For example, the method is started when starting a video conference software. The activation of the method may be controlled by the user, such as via a user interface. The method is then typically running in an ongoing manner until the speech or video conference is finished. In other words, the method is performed repeatedly or continually during the speech.

During the speech, images of the user are continually captured by the camera 22. For example, images are captured by a certain frame rate. The images may form a video that is also used by a video conference software. In other words, the method comprises capturing S1 images of the user 1 in an ongoing manner during the speech and using the camera 22.

The images are then analysed to detect the behaviour of the user 1. First a current body pose of the user is determined. In other words, the present posture of the user 1 is determined bases on feature analysis of the captured images. This at least involves detecting the head and/or the face of the user 1, which can be done using common feature detection techniques. In other words, the method comprises determining S2, based on feature recognition in the images, a current body pose of the user, including determining a head orientation of the user 1. In addition to head orientation the body pose may include head position, distance to camera and position and/or orientation of other body parts.

It is typically desirable to perform the analysis in an efficient manner. One way is to detect the nose of the user 1 and a direction corresponding to an extension of the nose, which would typically correspond to where the user is facing. In other words, in some embodiments, the determining S2 a current body pose comprises determining a direction d₁ that the user is facing by determining an angular direction of a nose of the user 1.

In addition to head orientation a gaze direction of the user may also be determined as described in patent publication WO2021040602 A1 (incorporated herein by reference). The gaze direction may then be used in combination with the body pose to evaluate the user's behaviour. In other words, in some embodiments, the determining S2 a current body pose also comprises determining a gaze direction of the user.

The analysis of the behaviour of the user also involves determining whether the user is speaking or not. In other words, the method comprises determining S3 whether the user 1 is currently speaking. This may be implemented in various ways, such as using the captured images of the user or alternatively or in addition based on an audio signal recorded by a microphone 23.

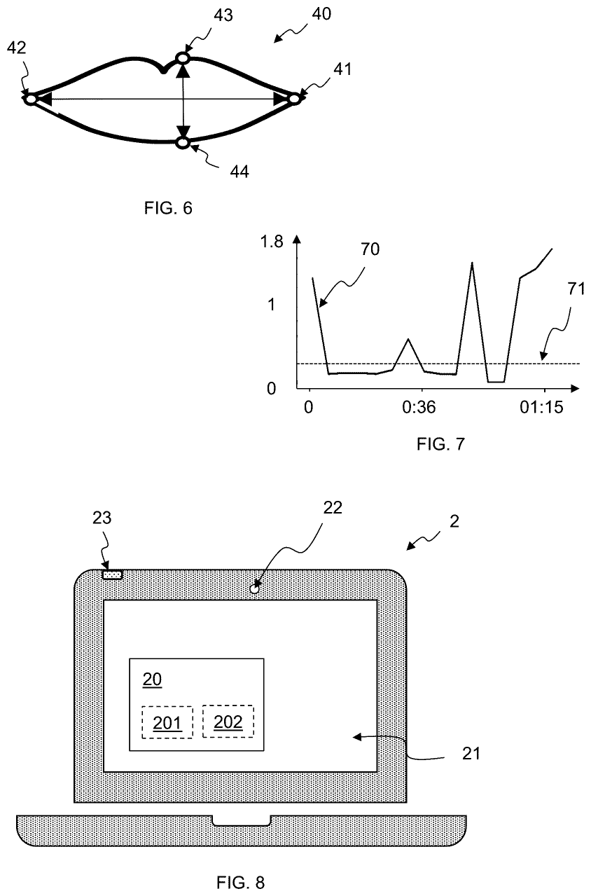

It may be preferable to base the analysis of the user's behaviour on the images, as the method would then not require any audio signal. This may also be relevant when the speaker is in a noisy environment, such that the user's speech cannot be distinguished from other people's speech or other noise. One possibility is to analyse amount of lip movement to decide whether the user is speaking. In other words, in some embodiments the determining S3 whether the user is speaking performed by analysing lip movement in the images. This will be described below with reference to FIGS. 6 and 7.

One way to establish that the user 1 is speaking is to measure how much different points at the user's mouth move in relation to each other. In other words, in some embodiments, the analysing comprises determining a variation of a distance between predefined positions along an outer boundary of the user's mouth.

Predefined or pre-programmed rules, or criteria, are then used to determine S4 whether the current body pose meet criteria defining executive presence. The rules are also based on whether the user 1 is speaking. More specifically criteria are evaluated to determine whether the current user behaviour (e.g., body pose and speaking) corresponds to executive presence. Any school of thought may be used for this purpose, such as the schools of thought described above. In some embodiments the criteria establish (or determine) executive presence based on that a deviation between a direction that the user is facing, and the camera 22, shall be below a predefined angle while the user is speaking, in order to give a feeling of eye contact. In some embodiments the criteria establish (or determine) executive presence based on that a deviation between a direction that the user is facing, and an image on the display 21 of a person of a virtual audience, shall be below a predefined angle while the user is speaking, to enable the user to read emotions of the virtual audience. Different schools of thought may be used singly or in combination, while considering various behavioral aspects. For example, the user 1 may select which school of thought to apply as a configurable setting of a user interface. One possibility is that both the schools described above are acceptable. Hence, only behavior that is deviating from both schools is corrected.

If executive presence is not established a user interface object 24 is displayed. The user interface object 24 teaches the user 1 how to rectify his behaviour in order to establish executive presence. In other words, the method further comprises, upon the determined current body pose failing to meet criteria defining executive presence based on (current) body pose and whether the user 1 is currently speaking, providing S5, on the display 21, a user interface object 24 indicative of a direction d₂ of a body movement that would result in a body pose that meets the criteria defining executive presence. The user interface object 24 constitutes feedback to the user. The feedback may comprise one or more aspects, such as a visual object and audio feedback. The provision of a direction may be combined with further instructions to the user, such as “speak slower”, “take a pause”, “change position”, “speak louder”, etc. The feedback may be provided in real-time based on real time analysis of the user behavior in accordance with steps S1-S4. In other words, is some embodiments the method is continually or repeatedly performed to provide live feedback to the user.

For the animated object position and orientation (left or right or center of the display 21) and the size (shorter or longer) of the user interface object 24 may depend on the user's current head position. In other words, in some embodiments, the user interface object 24 is indicative of a size of a deviation a between the current body pose and a body pose that would meet the criteria defining executive presence. The size of the deviation corresponds to the magnitude of a movement required to eliminate the deviation.

The size of the required body movement may be indicated in various ways. In other words, in some embodiments, the size is represented by a length, width, type, colour, contrast or animation of the user interface object 24. These mentioned properties may also be combined. For example, a large deviation is indicated by a long and red user interface object 24.

The animated feedback may be combined with audible feedback, such as stereo audio feedback. The audio feedback is in FIGS. 3 and 4 illustrated by a “volume icon” 25. For example, a sound will travel from left to right, or play simultaneously on both sides, based on the user's head position. In other words, in some embodiments, the providing S5 also comprises providing, to the user, a stereo audio signal indicative of the direction of the body movement that would result in a body pose that meets the criteria defining executive presence. Another possibility is that there will be a sound when the user's head orientation exceeds the angle α (FIG. 3b). The sound may become more intense (e.g., higher frequency or volume) the more the angle α is exceeded. The sound may be a stereo sound that is only present on the side of the deviation. In one example implementation, the sound may give the user the impression that he/she is bounding his/her head into something, when the angle α is exceeded. In some embodiments, the audio signal is used additional feedback when the body movement that would result in a body pose that meets the criteria defining executive presence exceeds a certain level.

It may also be important to the user 1 that the provided user interface object 24 is provided in a manner, such that it does not disturb the user 1. For example, it shall be avoided that the user interface object 24 covers other user interface objects 26 (FIG. 3b), which may be important to the user 1, such as speaker notes or images of the virtual audience. In some embodiments, the user interface object 24 is displayed based other user interface objects presented on the display, to avoid that the other user interface objects remain visible. For example, a diagonal direction may be represented by two arrows that when combined result in the direction d₂ of the body movement required for executive presence, see FIG. 3b.

The user 1 may also receive feedback when executive presence is re-established. For example, the user interface object 24 may simply disappear (or slowly fade out) when the user 1 has corrected his/her behaviour. In some embodiments, the method comprises ceasing S6 in providing the user interface object 24 upon the determined current body pose meeting criteria defining executive presence based on current body pose and whether the user is currently speaking. Further positive feedback may in addition be provided to encourage the user with the appropriate behaviour, such as a smiley or other suitable icon. In other embodiments, the user interface object 24 is dynamic, such that it represents the current deviation. Hence, when the user 1 starts to correct the deviation, the user interface object 24 may shrink or fade to indicate to the user 1 that there has been an improvement.

Example embodiments for the determining S3 whether the user is speaking will now be described. FIG. 6 illustrate positions along an outer boundary of the user's mouth 40. In some example embodiments, the determination S3 of whether the user is speaking is performed in the following manner. A plurality of points, here four points 41, 42, 43, 44 in the user's face are identified in the images. Thereafter, changes of the distance in the “lip ratios” between points 41 and 42 and between points 43 and 44 are calculated. Variations in the “lips ratios”, such as a standard deviation, are analyzed over a period of time, such as of 2-5 seconds. The analysis may be performed on an average, or sum, of the two “lip ratios”. Determination on whether the user 1 is talking, or not talking, is then performed based on a standard deviation reference 71 for detecting pausing (low stand deviation) vs talking (high standard deviation). FIG. 7 illustrate what the standard deviation curve 70 may look like and a standard deviation reference 71 of about 0.28.

FIG. 8 illustrates an electronic user device 2 comprising a one or more displays 21 and a camera 22 and a control arrangement 20. In the illustrated embodiment the electronic user device 2 is a personal computer. The control arrangement 20 comprises at least one processor 201 and memory 202. In general, the electronic user device 2, or more specifically the control arrangement 201 is configured to perform all embodiments of the method described herein. This might e.g., be achieved by executing software stored in the memory 202. More specifically, the control arrangement 20 is configured to cause the electronic user device 2 to capture, in an ongoing manner during the speech and using the camera 15, images of the user 1, to determine, based on feature recognition in the images, a current body pose of the user 1, including determining a head orientation of the user 1 and to determine whether the user 1 is currently speaking. The control arrangement 20 is also configured to upon the determined current body pose failing to meet criteria defining executive presence, based on current body pose and whether the user is currently speaking, provide, on the display 21, a user interface object indicative of a direction d₂ of a body movement that would result in a body pose that meets the criteria defining executive presence.

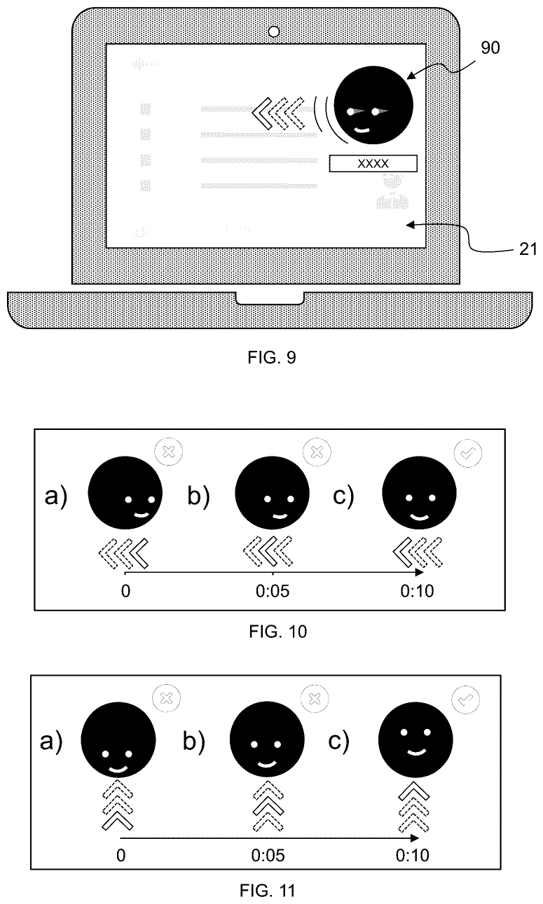

In some embodiments, the user interface object 24 comprises an image 90 of the user, as illustrated in FIG. 9. The image 90 may be an icon, a cartoon, a photo, or other suitable image. For example, the user interface object 24 comprises a reflection (a mirrored image) of the user giving the speech. The image 90 of the user 1 may be displayed on a part of the screen where the user 1 is currently looking. In FIG. 9 the user 1 is looking right. The image 90 of the user is then illustrated at the right side of the display 21. Similarly, the image may be displayed on the bottom of the display 21 if the user in looking down. The user interface object 24 may be presented on to of, or next to, other user interface objects. If the user interface object 24 is presented on top of other user interface objects 24 it may be transparent.

In some embodiments, the interface object 24 is animated and performs a movement starting at the user's current body pose and moving towards the target body pose that would result in a body pose that meets the criteria defining executive presence. Stated differently, in some embodiments the user interface object 24 is an animated object imaging a user 1 performing the body movement that would result in a body pose that meets the criteria defining executive presence.

FIG. 10 illustrate animation of the user interface object 24 imaging a user 1. More specifically FIG. 10 illustrate an icon representing a user performing a movement from an incorrect body pose, where the user 1 is looking right, to a correct body pose. The movement is illustrated by an animated icon that performs the movement. FIG. 10 shows how the icon changes over time (x-axis). For simplicity, only three positions are shown, but in a real implementation the movement may be gradually illustrated (like a video or GIF). In other words, when the animation of the image 90 is displayed the icon moves slowly from the incorrect body pose at the right (a) towards the target body pose at the left (c). FIG. 11 illustrate another movement that may be illustrated by an icon. More specifically, the icon illustrated in FIG. 11 instructs the user to “look up”. The icon is then typically displayed at the bottom of the display 21. Other more complex movements may also be illustrated, such as “first look up and then to the left” or “look up and to the right”.

The present invention is not limited to the above-described preferred embodiments. Various alternatives, modifications and equivalents may be used. Therefore, the above embodiments should not be taken as limiting the scope of the invention, which is defined by the appended claims.

1. A computer-implemented method, performed by an electronic user device comprising one or more displays and a camera, for training executive presence of a user when delivering a speech to a virtual audience though the electronic user device, the method comprising:
capturing images of the user in an ongoing manner during the speech and using the camera,
determining, based on feature recognition in the images, a current body pose of the user, including determining a head orientation of the user,
determining whether the user is currently speaking, and,
upon the determined current body pose failing to meet criteria defining executive presence based on body pose and whether the user is currently speaking,
providing, on the display, a user interface object indicative of a direction of a body movement that would result in a body pose that meets the criteria defining executive presence.

2. The method according to claim 1, wherein the user interface object is indicative of a size of a deviation between the current body pose and a body pose that would meet the criteria defining executive presence.

3. The method according to claim 2, where in the size is represented by a length, width, type, or animation of the user interface object.

4. The method according to claim 1, wherein the user interface object is an animated object imaging a user performing the body movement that would result in a body pose that meets the criteria defining executive presence.

5. The method according to claim 1, claims, wherein the providing also comprises providing, to the user, a stereo audio signal indicative of the direction of the body movement that would result in a body pose that meets the criteria defining executive presence.

6. The method according to claim 1, wherein the user interface object is displayed based other user interface objects presented on the display, to avoid that the other user interface objects remain visible.

7. The method according to claim 1, comprising:
ceasing in providing the user interface object upon the determined current body pose meeting criteria defining executive presence based on body pose and whether the user is currently speaking.

8. The method according to claim 1, wherein the criteria establish executive presence based on that:
a deviation between a direction that the user is facing, and the camera, shall be below a predefined angle while the user is speaking, in order to give a feeling of eye contact, or
a deviation between a direction that the user is facing, and an image on the display of a person of a virtual audience, shall be below a predefined angle while the user is speaking, to enable the user to read emotions of the virtual audience.

9. The method according to claim 1, wherein the determining whether the user is speaking performed by analysing lip movement in the images.

10. The method according to claim 9, wherein the analysing comprises determining a variation of the distance between predefined positions along an outer boundary of the user's mouth.

11. The method according to claim 1, wherein the determining a current body pose also comprises determining a gaze direction of the user.

12. The method according to claim 1, wherein the speech takes place in a video conference, and wherein the user interface object is presented within or adjacent to the user interface of a video conference interface of the video conference.

13. (canceled)

14. A non-transitory computer-readable medium storing a computer program comprising instructions which, when executed by a computer, cause the computer to carry out the method according to claim 1.

15. An electronic user device comprising a one or more displays and a camera, wherein the electronic user device comprises a control arrangement configured to cause the electronic user device to:
capture, in an ongoing manner during the speech and using the camera, images of the user,
determine, based on feature recognition in the images, a current body pose of the user, including determining a head orientation of the user, determine whether the user is currently speaking, and
upon the determined current body pose failing to meet criteria defining executive presence based on body pose and whether the user is currently speaking,
provide on the display, a user interface object indicative of a direction of a body movement that would result in a body pose that meets the criteria defining executive presence.

16. (canceled)
